(19) United States
(12) Patent Application Publication
(10) Pub. No.: US 2010/0246526 A1
(43) Pub. Date: Sep. 30, 2010

(54) Apparatus and method for allocating sounding sequences in a broadband wireless communication system

(75) Inventors: Li Jing, Suwon-si (KR); Soon-Young Yoon, Seoul (KR); Keun-Chul Hwang, Yongin-si (KR); In-Seok Hwang, Seoul (KR); June Moon, Seoul (KR)

Correspondence Address: DOCKET CLERK, P.O. DRAWER 800889, DALLAS, TX, 75380, US

(73) Assignee: Samsung Electronics Co., Ltd., Suwon-si (KR)

(21) Appl. No.: 12/798,302

(22) Filed: Mar. 31, 2010

(30) Foreign Application Priority Data
Mar. 31, 2009 (KR) 10-2009-0027403

(51) Int. Cl. H04W 72/00

(52) U.S. Cl. 370/329

(57) ABSTRACT

A method and apparatus enhances sounding performance for a broadband wireless communication system of a multi-cell environment. A grouping part groups a plurality of sounding sequences to a plurality of sequence groups. A first determiner determines a correlation between the sequence groups. A second determiner determines a least interference relation between sectors in a cluster. An allocator allocates the sequence groups to the sectors based on the correlation between the sequence groups and the least interference relation between the sectors.

### CROSS-REFERENCE TO RELATED APPLICATION(S) AND CLAIM OF PRIORITY

The present application claims the benefit under 35 U.S.C. §119(a) to a Korean patent application filed in the Korean Intellectual Property Office on Mar. 31, 2009, and assigned Serial No. 10-2009-0027403, the entire disclosure of which is hereby incorporated by reference.

### TECHNICAL FIELD OF THE INVENTION

The present invention relates generally to a broadband wireless communication system. More particularly, the present invention relates to an apparatus and a method for allocating sounding sequences in the broadband wireless communication system.

### BACKGROUND OF THE INVENTION

A fourth generation (4G) communication system, which is a next-generation communication system, is under development to provide users with services of various Quality of Service (QoS) levels at a data rate of about 100 Mbps. Particularly, the 4 G communication systems are advancing in order to support high speed services by providing mobility and QoS in Broadband Wireless Access (BWA) communication systems such as wireless local area network systems and wireless metropolitan area network systems. Representative examples include an Institute of Electrical and Electronics Engineers (IEEE) 802.16 communication system.

According to the IEEE 802.16 system standard, a terminal transmits an uplink sounding signal to estimate a channel of a base station. Mostly, the sounding signal is defined as a set of orthogonal sequences, and the terminal transmits the sounding signal generated from one of the sequences. A plurality of terminals can transmit their sounding signals over the same resource. Hence, it is quite important to prevent interference between the sounding signals by maintaining the orthogonality between the sounding sequences. In a multi-cell environment, the same resource in the cells can be used as the sounding channel. In this situation, the same sounding signals can be transmitted over the same resources in the neighboring cells, which cause Inter-Cell Interference (ICI) of the sounding signal. That is, in the multi-cell environment, the ICI may greatly deteriorate the sounding performance. In this regard, there is a need for a solution to maintain the orthogonality between the sounding sequences and to prevent the ICI of the sounding signals by obtaining as many sounding sequences as possible within the limited sequence length.

### SUMMARY OF THE INVENTION

To address the above-discussed deficiencies of the prior art, it is a primary aspect of the present invention to provide an apparatus and a method for enhancing sounding performance in a broadband wireless communication system.

Another aspect of the present invention is to provide an apparatus and a method for reducing Inter Cell Interference (ICI) of a sounding signal in a broadband wireless communication system.

Yet another aspect of the present invention is to provide an apparatus and a method for sounding using a number of sounding sequences in a broadband wireless communication system.

Still yet another aspect of the present invention is to provide an apparatus and a method for generating a sounding sequence applicable to various sequence lengths in a broadband wireless communication system.

According to one aspect of the present invention, a sounding sequence allocating method for a broadband wireless communication system of a multi-cell environment includes grouping a plurality of sounding sequences to a plurality of sequence groups. The method also includes determining a correlation between the sequence groups and determining a least interference relation between sectors in a cluster. The method further includes allocating the sequence groups to the sectors based on the correlation between the sequence groups and the least interference relation between the sectors.

According to another aspect of the present invention, a sounding sequence allocating method for a broadband wireless communication system of a multi-cell environment includes generating base sounding sequences by multiplying a Zadoff-Chu sequence of a preset root index by a plurality of covering codes. The base sounding sequences generated from first covering codes different from each other are allocated to sectors in a cell.

According to yet another aspect of the present invention, a sounding sequence allocating apparatus for a broadband wireless communication system of a multi-cell environment includes a grouping part that groups a plurality of sounding sequences to a plurality of sequence groups. A first determiner determines correlation between the sequence groups. A second determiner determines a least interference relation between sectors in a cluster. An allocator allocates the sequence groups to the sectors based on the correlation between the sequence groups and the least interference relation between the sectors.

According to still another aspect of the present invention, a sounding sequence allocating apparatus for a broadband wireless communication system of a multi-cell environment includes a generator that generates base sounding sequences by multiplying a Zadoff-Chu sequence of a preset root index by a plurality of covering codes. An allocator allocates base sounding sequences generated from first covering codes different from each other to sectors in a cell.

According to yet another aspect of the present invention, a broadband wireless communication system of a multi-cell environment includes a first base station belonging to a first cell of four cells constituting a cluster. The first base station is configured to manage a first sector of four sectors having least interference relation, and control a mobile station to perform sounding using sounding sequences of a first sequence group among four sequence groups having correlation with respect to the first sector. A second base station belonging to a second cell of the four cells constituting the cluster is configured to manage a second sector of the four sectors having the least interference relation and control a mobile station to perform sounding using sounding sequences of a second sequence group among four sequence groups having correlation with respect to the second sector. A third base station for belonging to a third cell of the four cells constituting the cluster is configured to manage a third sector of the four sectors having the least interference relation and control a mobile station to perform sounding using sounding sequences of a third sequence group among four sequence groups having correlation with respect to the third sector A fourth base station for belonging to a fourth cell of the four cells constituting the cluster is configured to manage a fourth sector of the four sectors having the least interference relation and control a mobile station to perform sounding using sounding sequences of a fourth sequence group among four sequence groups having correlation with respect to the fourth sector.

According to a further aspect of the present invention, a broadband wireless communication system of a multi-cell environment includes a first base station configured to control a mobile station to perform sounding using sounding sequences generated from base sounding sequences which comprise first covering codes having different indexes with respect to sectors constituting a cell of the first base station. A second base station is configured to control a mobile station to perform sounding using sounding sequences generated from a base sounding sequence comprising a first covering code having a different index from an index of a first covering code of a base sounding sequence of a first sector with respect to at least one sector of the second base station, the at least one sector adjacent to a first sector of the first base station. The base sounding sequence is generated by multiplying a Zadoff-Chu sequence of a preset root index by a plurality of covering codes.

Other aspects, advantages, and salient features of the invention will become apparent to those skilled in the art from the following detailed description, which, taken in conjunction with the annexed drawings, discloses exemplary embodiments of the invention.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 conceptually illustrates generation of sounding sequences in a broadband wireless communication system according to an embodiment of the present invention;

FIG. 2 illustrates correlation between sequence groups in the broadband wireless communication system according to an embodiment of the present invention;

FIG. 3 illustrates definition of sector indexes in a cluster in the broadband wireless communication system according to an embodiment of the present invention;

FIG. 4 illustrates minimum interference relation between sectors in the broadband wireless communication system according to an embodiment of the present invention;

FIG. 5 illustrates a sounding sequence allocating method in the broadband wireless communication system according to one embodiment of the present invention;

FIG. 6 illustrates a sounding sequence allocating method in the broadband wireless communication system according to an embodiment of the present invention;

FIG. 7 illustrates a sequence allocating apparatus in the broadband wireless communication system according to an embodiment of the present invention;

FIG. 8 illustrates a sequence allocating apparatus in the broadband wireless communication system according to an embodiment of the present invention;

FIGS. 9A and 9B illustrate sequence allocation results in the broadband wireless communication system according to an embodiment of the present invention; and

FIGS. 10A and 10B illustrate performance of the broadband wireless communication system according to an embodiment of the present invention.

Throughout the drawings, like reference numerals will be understood to refer to like parts, components and structures.

### DETAILED DESCRIPTION OF THE INVENTION

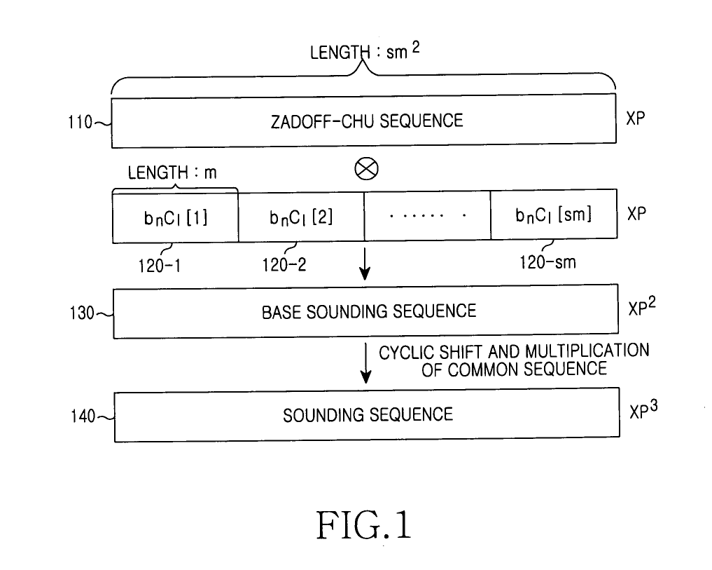

FIGS. 1 through 10B, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communications system.

Embodiments of the present invention provide a technique for increasing sounding performance in a broadband wireless communication system. In particular, the present invention provides a technique for preventing interference of the sounding between cells by effectively allocating sounding sequences. Hereinafter, Orthogonal Frequency Division Multiplexing (OFDM)/Orthogonal Frequency Division Multiple Access (OFDMA) wireless communication system is illustrated by way of example. Note that the present invention is applicable to other various wireless communication systems.

First, characteristics of the sounding sequence under consideration are explained.

The present invention fulfills the sounding using sounding sequences generated based on Zadoff-Chu sequences. Provided that the length of the sounding sequence is P, the Zadoff-Chu sequences on which the sequence is based are generated based on Equation 1 or Equation 2. Equation 1 is applied when the sequence length P is an even number and Equation 2 is applied when the sequence length P is an odd number.

aᵣ[n]=e^{-jπrn}^{²}^{/P}, n=0,1 . . . P−1, when P is even [Eqn. 1]

In Equation 1, aᵣ[n] denotes the n-th element of the Zadoff-Chu sequence, n denotes a tone index, r denotes a root index of the Zadoff-Chu sequence, and P denotes the length of the Zadoff-Chu sequence. Herein, n and r are integers greater than 0 and less than P−1.

aᵣ[n]=e^{-jπrn(n+1)/P}, n=0,1 . . . P−1, when P is odd [Eqn. 2]

In Equation 2, aᵣ[n] denotes the n-th element of the Zadoff-Chu sequence, n denotes the tone index, r denotes the root index of the Zadoff-Chu sequence, and P denotes the length of the Zadoff-Chu sequence. Herein, n and r are integers greater than 0 and less than P−1.

Based on Equation 1 or Equation 2, r-ary in total; that is, P-ary Zadoff-Chu sequences are generated. To generate the sounding sequences based on the P-ary Zadoff-Chu sequences, the present invention utilizes P-ary covering codes. To generate the covering codes, P is resolved to the product of two constant values; that is, the product (=sm²) of the first constant s and the square of the second constant m. In this embodiment, the covering code is expressed as the product of two orthogonal codes. For example, the orthogonal code can employ a Discrete Fourier Transform (DFT) code. Given two orthogonal codes b and c, the covering codes are generated based on Equation 3:

$$\begin{matrix}{v}_{u , l} [ n ] = {b}_{u} [ n mod m ] {c}_{l} [ ⌈ n / m ⌉ ] \\ = {e}^{- j2π u ( n mod m ) / m} {e}^{- j2π l ⌈ n / m ⌉ / sm} \\ , u = 0 , 1 … m - 1 ; 1 = 0 , 1 … sm - 1\end{matrix} \qquad [ Eqn . 3 ]$$

In Equation 3, v_{u,l}[n] is the n-th element of the covering code with the index u, l, u is the index of the first orthogonal code, l is the index of the second orthogonal code, n is the tone index, bᵤ is the first orthogonal code of the index u, m is the second constant constituting P, cₗ is the second orthogonal code of the index l, ┌•┐ is a round-up operator, and s is the first constant constituting P. Herein, u is an integer greater than 0 and less than m−1, and l is an integer greater than 0 and less than sm−1.

Based on Equation 3, u×l-ary; that is, P-ary covering codes are produced. In Equation 3, the first orthogonal code is to enhance the correlation characteristic between the finally generated sequences; that is, to lower the correlation value. The second orthogonal code is to generate even more sequences while holding the correlation characteristics similar to the correlation characteristics of the sequence constituted merely with the first orthogonal code. After generating the P-ary covering codes, the present invention generates P²-ary base sounding sequences by multiplying the P-ary Zadoff-Chu sequences by the P-ary covering codes respectively. The Zadoff-Chu sequence and the covering code are multiplied based on Equation 4

g_{r,u,l}[n]=aᵣ[n]v_{u,l}[n], n=0,1 . . . P−1 [Eqn. 4]

In Equation 4, g_{r,u,l}[n] denotes the n-th element of the base sounding sequence with the index r,u,l, k is the tone index, aᵣ[k] denotes the n-th element of the Zadoff-Chu sequence with the root index r, and v_{u,l}[n] denotes the n-th element of the covering sequence with the index u,l. Herein, n is an integer greater than 0 and less than P−1.

Based on Equation 4, the P²-ary base sounding sequences are produced. The present invention generates P-ary sounding sequences per base sounding sequence using a cyclic shift. The sounding sequence is generated based on Equation 5:

C_{q,r,u,l}[k]=g_{r,u,l}[(k+q)mod P]f[k], k=0,1 . . . N_{used}−1 [Eqn. 5]

In Equation 5, c_{q,r,u,l}[k] denotes the k-th element of the sounding sequence with the index q,r,u,l, q denotes a cyclic shift offset, g_{r,u,l} denotes the base sounding sequence with the index r,u,l, k denotes the tone index, P denotes the length of the sounding sequence, f[k] denotes the k-th element of a common covering sequence, and N_{used} denotes the number of usable tones for sending the sounding sequence. Herein, q is an integer greater than 0 and less than P−1. f[k] is an factor for decreasing a Peak to Average Power Ratio (PAPR) of the sounding sequence and is applied commonly to every sequence regardless of the index q,u,l. For example, f[k] can employ one of a Golay sequence, a random sequence, an All-one sequence, and a sequence given by Equation 6:

$$f [ k ] = {e}^{- \frac{jπ yk ( k + 1 )}{{N}_{G}}} \qquad [ Eqn . 6 ]$$

In Equation 6, f[k] denotes the k-th element of the common covering sequence, k denotes the tone index, N_{G} denotes a minimum prime number among the positive integers greater than the total number of the tones, and y denotes a value selected to minimize the PAPR of the sounding sequence among the positive integers between 1 and N_{G}−1. Herein, N_{G} and y are set to the same value in every base station. For example, when the number of the tones is 864, N_{G} is 877.

Based on Equation 5, P³-ary sounding sequences are produced. Herein, the sounding sequences generated from the same base sounding sequence are referred to as a sounding sequence set.

As stated above, the sounding sequences are generated based on Equation 1 through Equation 5. The generation of the sounding sequences is conceptually depicted in FIG. 1. Referring to FIG. 1, the P-ary Zadoff-Chu sequences 110 are multiplied by the covering codes 120-1 through 120-sm, respectively. In so doing, P-ary covering code sets are used. In result, P²-ary base sounding sequences 130 are produced. Through the cyclic shift and the multiplication with the common covering sequence, P-ary sounding sequences are generated from each of the base sounding sequences 130; that is, P³-ary sounding sequences are produced. According to the principles of the present invention, the number of the Zadoff-Chu sequences can be limited. For instance, when only one Zadoff-Chu sequence is used, P²-ary sounding sequences are produced.

The generated sounding sequences as stated above are allocated to the cells, respectively, and the base station managing the cell instructs to transmit the sounding sequences allocated to its cell to terminals. The occurrence and the magnitude of the interference between the sounding sequences rely on which sounding sequence the terminals in each cell transmit, which directly relates to the sounding performance.

To mitigate the interference through the sequence allocation, it is desirable to provide orthogonality in the same sector. For doing so, the present invention provides two embodiments. According to the first embodiment, the sequence allocation is independent of the cell disposition and randomly conducted. According to the second embodiment, the sequence allocation is performed on the sequence group basis. Herein, the sequence group is determined by a cell pattern and reused in different cell clusters. Hereafter, the sequence allocation is explained on the assumption that the sounding sequence set is generated from one Zadoff-Chu root index.

In the first embodiment, sectors constituting the cell are each the target of the sequence allocation, and the sequence allocation is carried out on the base sounding sequence basis. First, the base sounding sequence g_{u,l} to be allocated to the sector is determined. In the index u,l for identifying the base sounding sequence, u is an index of the covering code b and corresponds to each sector. l is an index of the covering code c and is randomly selected with respect to each sector. That is, sectors adjacent to each other are assigned the base sounding sequences identified by the random l and the different u. Accordingly, within one sector, the P-ary sounding sequences obtained from the single base sounding sequence through the cyclic shift are used.

In the second embodiment, the sectors constituting the cell are each the target of the sequence allocation, and the sequence allocation is carried out based on the sounding sequence group that is grouped according to a rule. Notably, only one covering code c is used in this embodiment. For example, when the sequence length P is ‘18’, the number of available covering codes b is three, and the index l indicative of the covering code c is fixed to zero, fifty-four (54=18×3) sounding sequences in total can be used. In this situation, twelve sounding sequence groups are formed as shown in Table 1. In Table 1, the sequence code is expressed as C_{q,u,l}, where q is the cyclic shift offset, u is the index of the covering code b, and l is the index of the covering code c.

TABLE 1

| group 1 | C_{1,1,0}~C_{4,1,0} |
|---|---|
| group 2 | C_{1,2,0}~C_{4,2,0} |
| group 3 | C_{1,3,0}~C_{4,3,0} |
| group 4 | C_{5,1,0}~C_{8,1,0} |
| group 5 | C_{5,2,0}~C_{8,3,0} |
| group 6 | C_{5,3,0}~C_{8,3,0} |
| group 7 | C_{9,1,0}~C_{12,1,0} |
| group 8 | C_{9,2,0}~C_{12,2,0} |
| group 9 | C_{9,3,0}~C_{12,3,0} |
| group | C_{13,1,0}~C_{16,1,0} |
| 10 | |
| group | C_{13,2,0}~C_{16,2,0} |
| 11 | |
| group | C_{13,3,0}~C_{16,3,0} |
| 12 | |

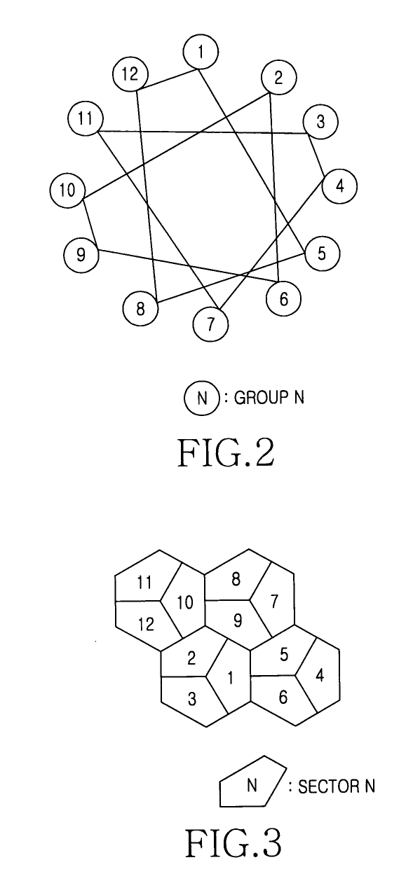

As shown in Table 1, 48 sounding sequences can be used in total and each group includes four sounding sequences. The sounding sequences in each group have the orthogonality in the corresponding group. In twelve groups, the sounding sequences of each group are not orthogonal to the sounding sequences of other three of the remaining 11 groups. That is, the sounding sequences of one particular group interfere with the sounding sequences of three other particular groups. The interference relation, that is, the correlation between the groups is shown in FIG. 2. In FIG. 2, four groups linked by one closed curve are in the correlation. In more detail, as group 1, group 5, group 8 and group 12 have correlation in FIG. 2, the sounding sequences of group 1 are not orthogonal to the sounding sequences of groups 5, group 8, and group 12.

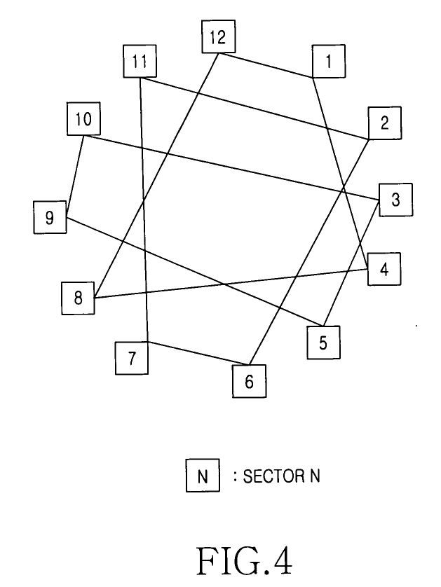

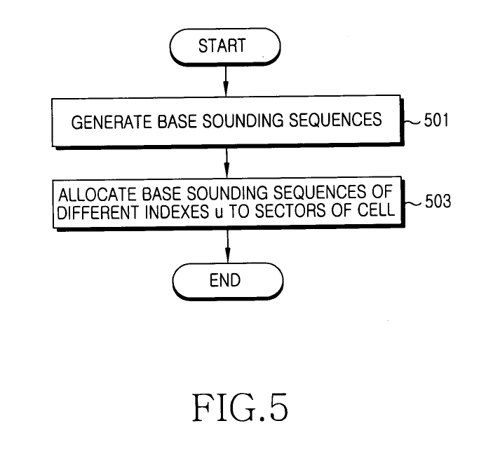

In one cluster consisting of four cells, the sector indexes for identifying the sectors can be defined as shown in FIG. 3. The four cells in one cluster are assigned different sounding sequences, and the sequence can be reused in a different cluster. In consideration of a long-term path loss, three sectors having least interference to each other can be selected with respect to each individual sector. When the indexes of the sectors are defined as shown in FIG. 3, the sectors of the least mutual interference can be bound as shown in FIG. 4. In FIG. 4, four sectors linked by one closed curve are in the least interference relation. As shown in FIG. 4, sector 1, sector 4, sector 8, and sector 12 have the least interference relation, sector 2, sector 6, sector 7, and sector 11 have the least interference relation, and sector 3, sector 5, sector 9 and sector 10 have the least interference relation.

As such, in another embodiment, the sequence allocation is based on the least interference relation among the sectors and the correlation between the sequence groups. In other words, the sectors with the least interference relation are assigned the sequence groups of the correlation. Thus, the interference between the sequences caused by the correlation is suppressed by the least interference relation between the sectors. The result of the sounding sequence allocation to the sectors as stated above is shown in Table 2.

TABLE 2

| | Sector | | |
|---|---|---|---|
| cell/sector | index | Sounding sequence | |
| cell1 sector1 | 1 | group1 | C_{1, 1, 0,} C_{2, 1, 0,} C_{3, 1, 0,} C_{4, 1, 0} |
| cell1 sector2 | 2 | group2 | C_{1, 2, 0,} C_{2, 2, 0,} C_{3, 2, 0,} C_{4, 2, 0} |
| cell1 sector3 | 3 | group3 | C_{1, 3, 0,} C_{2, 3, 0,} C_{3, 3, 0,} C_{4, 3, 0} |
| cell2 sector1 | 4 | group5 | C_{5, 2, 0,} C_{6, 2, 0,} C_{7, 2, 0,} C_{8, 2, 0} |
| cell2 sector2 | 5 | group4 | C_{5, 1, 0,} C_{6, 1, 0,} C_{7, 1, 0,} C_{8, 1, 0} |
| cell2 sector3 | 6 | group6 | C_{5, 3, 0,} C_{6, 3, 0,} C_{7, 3, 0,} C_{8, 3, 0} |
| cell3 sector1 | 7 | group9 | C_{9, 3, 0,} C_{10, 3, 0,} C_{11, 3, 0,} C_{12, 3, 0} |
| cell3 sector2 | 8 | group8 | C_{9, 2, 0,} C_{10, 2, 0,} C_{11, 2, 0,} C_{12, 2, 0} |
| cell3 sector3 | 9 | group7 | C_{9, 1, 0,} C_{10, 1, 0,} C_{11, 1, 0,} C_{12, 1, 0} |
| cell4 sector1 | 10 | group11 | C_{13, 2, 0,} C_{14, 2, 0,} C_{15, 2, 0,} C_{16, 2, 0} |
| cell4 sector2 | 11 | group10 | C_{13, 1, 0,} C_{14, 1, 0,} C_{15, 1, 0,} C_{16, 1, 0} |
| cell4 sector3 | 12 | group12 | C_{13, 3, 0,} C_{14, 3, 0,} C_{15, 3, 0,} C_{16, 3, 0} |

Now, a method and an apparatus for allocating the sounding sequences as above are elucidated by referring to the drawings. Hereinafter, a subject which allocates the sounding sequences is referred to as a sequence allocator, and an apparatus for allocating the sounding sequences is referred to as a sequence allocating apparatus.

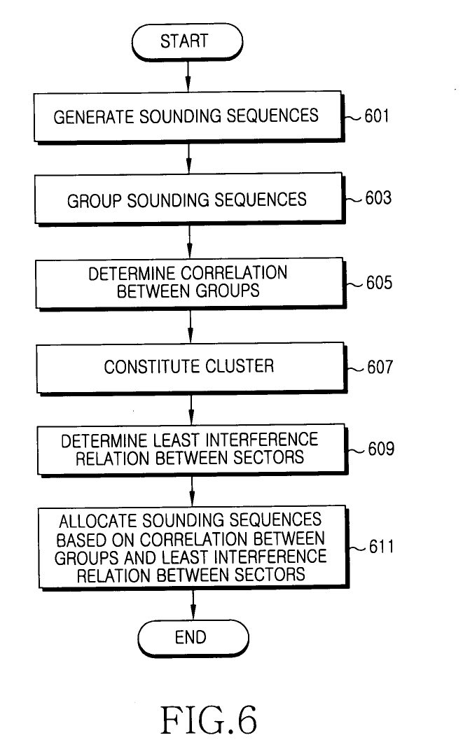

FIG. 5 illustrates a sounding sequence allocating method in the broadband wireless communication system according to one embodiment of the present invention.

In block 501, the sequence allocator generates the base sounding sequences. More specifically, the sequence allocator generates the Zadoff-Chu sequence based on the root index defined, and generates the base sounding sequences by multiplying the Zadoff-Chu sequence by the covering codes b and the covering codes c. That is, the sequence allocator generates the base sounding sequences based on Equation 1 through Equation 4.

In block 503, the sequence allocator allocates the base sounding sequences of the different index u to the sectors of the cell. The sequence allocator allocates the base sounding sequences such that there are no sectors which use the base sounding sequence generated from the same covering code b among the sectors of the cell. Yet, when the sequence allocation is executed to the neighbor cell of the sequence allocation target cell, the sequence allocator assigns the base sounding sequences by considering the sector of the other cell adjacent to the allocation target cell. In other words, the sequence allocator prevents the sector of the allocation target cell and the sector of the other cell, which are adjacent to each other, from being allocated the base sounding sequence of the same index u.

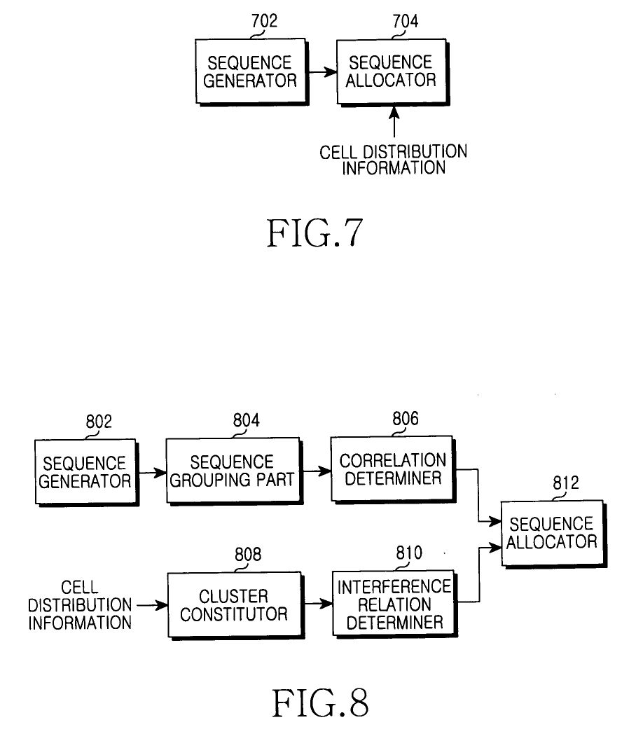

FIG. 6 illustrates a sounding sequence allocating method in the broadband wireless communication system according to an embodiment of the present invention.

In block 601, the sequence allocator generates the sounding sequences. More specifically, the sequence allocator generates the Zadoff-Chu sequence according to the set root index, generates the base sounding sequences by multiplying the Zadoff-Chu sequence by the covering codes b and the covering codes c, and generates the sounding sequences by applying the cyclic shift to the base sounding sequences respectively. That is, the sequence allocator generates the sounding sequences based on Equation 1 through Equation 5. The single covering code c is fixed.

In block 603, the sequence allocator groups the sounding sequences. The grouping conforms to a preset rule, and the detailed rule varies according to the principles of the present invention. For instance, the sequence allocator constitutes as many sequence groups as the sectors in the allocation range. When the allocation range is the cluster including four cells, the sequence allocator constitutes twelve sequence groups. In so doing, the sequence allocator divides the sounding sequences to higher groups based on the covering code b, splits the range of the cyclic shift offset in each higher group, and thus constitutes the sequence groups. For example, the sequence allocator constitutes the sequence groups of Table 1.

In block 605, the sequence allocator determines the correlation between the sequence groups. Herein, the correlation implies the mutual interference relation. In other words, the sequence allocator identifies the group sets which are not orthogonal among the sequence groups constituted in block 603. Hereafter, the correlation of FIG. 2 is assumed.

In block 607, the sequence allocator constitutes the cluster. Herein, the cluster is a group of cells which include as many sectors as the sequence groups. When the number of the sequence groups is twelve, the sequence allocator constitutes the cluster including twelve sectors, including four cells. Namely, the sequence allocator constitutes one cluster with four adjacent cells. Hereafter, the cluster of FIG. 3 is assumed.

In block 609, the sequence allocator determines the least interference relation between the sectors. Herein, the least interference relation implies the relation that exerts relatively less interference and is determined by the geographical location and the environment between the sectors. Hereafter, the least interference relation of FIG. 4 is assumed.

In block 611, the sequence allocator allots the sequence groups to the sectors by taking into account the correlation between the sequence groups and the least interference relation between the sectors. That is, the sequence allocator allocates the sequence groups such that the sectors of the least interference relation are assigned the sequence groups of the correlation. For example, given the correlation of FIG. 2 and the least interference relation of FIG. 4, the sequence allocator assigns the sequence groups as shown in Table 2.

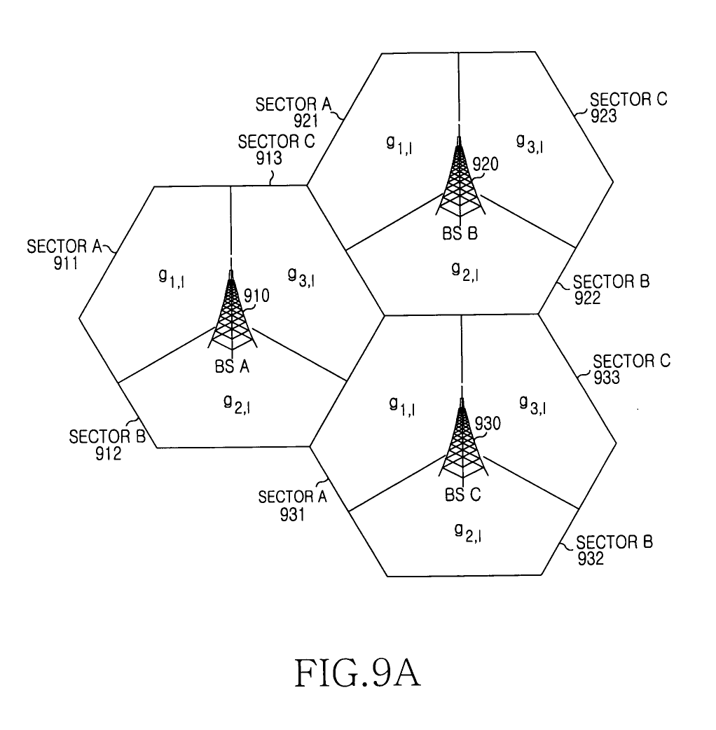

FIG. 7 is a block diagram of a sequence allocating apparatus in the broadband wireless communication system according to one embodiment of the present invention.

The sequence allocating apparatus of FIG. 7 includes a sequence generator 702 and a sequence allocator 706.

The sequence generator 702 generates the base sounding sequences allocated to the sectors. In more detail, the sequence generator 702 generates the Zadoff-Chu sequence based on the set root index, and generates the base sounding sequences by multiplying the Zadoff-Chu sequence by the covering codes b and the covering codes c. That is, the sequence generator 702 generates the base sounding sequences based on Equation 1 through Equation 4.

The sequence allocator 704 allocates the base sounding sequences of the different indexes u to the sectors of the cell. Herein, the index u indicates the index of the covering code b. More specifically, the sequence allocator 704 assigns the base sounding sequences such that the sectors of one cell do not use the base sounding sequence generated from the same covering code b. When the sequence is allocated to the neighbor cell of the sequence allocation target cell, the sequence allocator 704 allocates the base sounding sequences by considering the sectors of the other cell adjacent to the allocation target cell. In other words, the sequence allocator 704 blocks the sector of the allocation target cell and the sector of the other cell, which are adjacent to each other, from being allocated the base sounding sequence of the same index u.

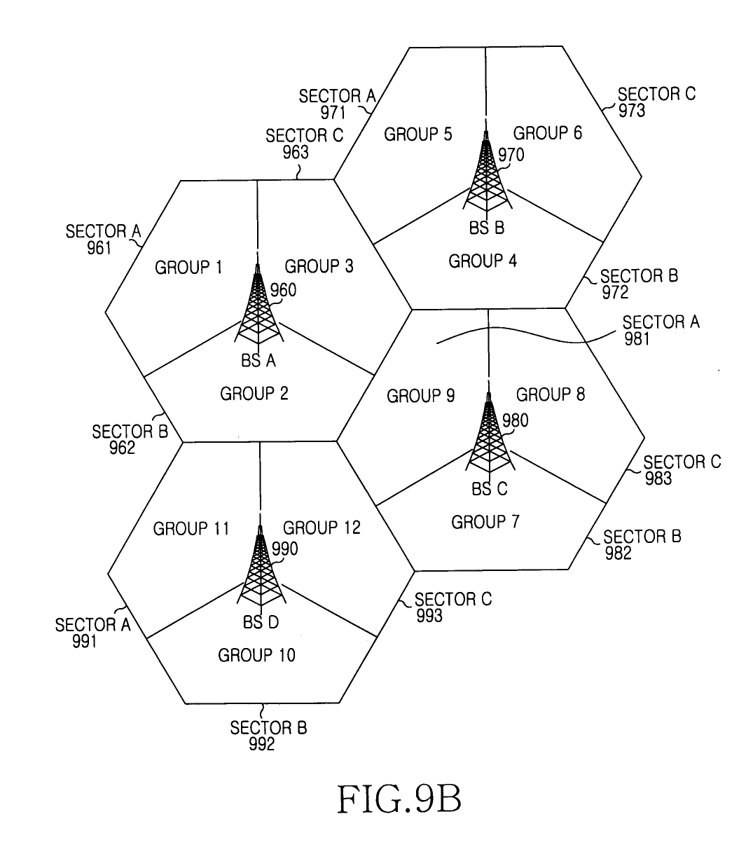

FIG. 8 is a block diagram of a sequence allocating apparatus in the broadband wireless communication system according to an embodiment of the present invention.

The sequence allocating apparatus of FIG. 8 includes a sequence generator 802, a sequence grouping part 804, a correlation determiner 806, a cluster constitutor 808, an interference relation determiner 810, and a sequence allocator 812.

The sequence generator 802 generates the sounding sequences. In more detail, the sequence generator 802 generates the Zadoff-Chu sequence based on the set root index, generates the base sounding sequences by multiplying the Zadoff-Chu sequence by the covering codes b and the covering codes c, and generates the sounding sequences by applying the cyclic shift to the base sounding sequences. That is, the sequence generator 802 generates the sounding sequences based on Equation 1 through Equation 5. The single covering code c is fixed.

The sequence grouping part 804 groups the sounding sequences generated by the sequence generator 802. The grouping conforms to the preset rule, and the detailed rule varies according user preferences. For instance, the sequence grouping part 804 constitutes as many sequence groups as the sectors in the allocation range. When the allocation range is the cluster including four cells, the sequence grouping part 804 constitutes 12 sequence groups. In so doing, the sequence grouping part 804 divides the sounding sequences to higher groups based on the covering code b, splits the range of the cyclic shift offset in each higher group, and thus constitutes the sequence groups. For example, the sequence grouping part 804 constitutes the sequence groups of Table 1.

The correlation determiner 806 checks the correlation between the sequence groups. Herein, the correlation implies the mutual interference relation. In other words, the correlation determiner 806 identifies the group sets which are not orthogonal among the sequence groups constituted by the sequence grouping part 804. Hereafter, the correlation of FIG. 2 is assumed.

The cluster constitutor 808 constitutes the cluster. Herein, the cluster is a group of cells which include as many sectors as the sequence groups. When the number of the sequence groups is twelve, the cluster constitutor 808 constitutes the cluster including twelve sectors, including four cells. Namely, the cluster constitutor 808 constructs one cluster with four adjacent cells. Hereafter, the cluster of FIG. 3 is assumed.

The interference relation determiner 810 checks the least interference relation between the sectors. Herein, the least interference relation implies the relation exerting the relatively less interference and is determined by the geographical location and the environment between the sectors. Hereafter, the least interference relation of FIG. 4 is assumed.

The sequence allocator 812 allots the sequence groups to the sectors by taking into account the correlation between the sequence groups and the least interference relation between the sectors. That is, the sequence allocator 812 allocates the sequence groups such that the sectors of the least interference relation are assigned the sequence groups of the correlation. For example, given the correlation of FIG. 2 and the least interference relation of FIG. 4, the sequence allocator 812 assigns the sequence groups as shown in Table 2.

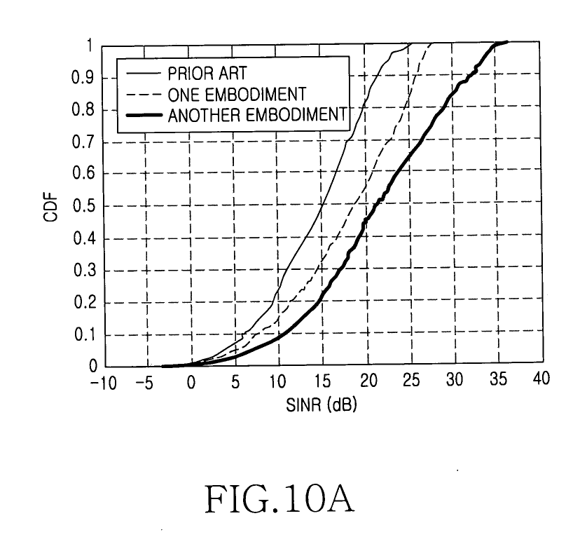

FIGS. 9A and 9B illustrate the sequence allocation results in the broadband wireless communication system according to an embodiment of the present invention. FIG. 9A shows the sequence allocation result according to one embodiment of the present invention, and FIG. 9B shows the sequence allocation result according to another embodiment of the present invention.

In FIG. 9A, the letter written in each sector indicates the allocated base sounding sequence, the first subscript denotes the index of the covering code b, and the second subscript denotes the index of the covering code c. The covering code c is allocated randomly and written as the letter ‘l’, rather than a specific value. Referring to FIG. 9A, a Base Station (BS) A 910, a BS B 920, and a BS C 930 each manage three sectors 911, 912, 913, 921, 922, 923, 931, 932 and 933, and one base sounding sequence is allocated per sector. BS A 910, BS B 920, and BS C 930 generate the base sounding sequences of the sectors by applying the cyclic shift to the base sounding sequence allocated to each sector, and direct a Mobile Station (MS) to transmit one of the sounding sequences of the sector where the MS travels. For example, the BS A 910 directs the MS traveling in sector A 911 to transmit one of the sounding sequences generated from the base sounding sequence g_{1,l}. In one embodiment of the present invention, the BSs 910, 920 and 930 use the base sounding sequence generated from the different covering code b with respect to the sectors in their cell as shown in FIG. 9A. Still, with respect to the sectors in the different cell, the BSs 910, 920 and 930 use the base sounding sequence generated from the different covering code b with respect to the neighboring sectors. That is, as shown in FIG. 9A, BS B 920 uses the base sounding sequence g_{2,l} for sector B 922, and BS C 930 uses the base sounding sequence g_{1,l} for sector A 931, which is adjacent to sector B 922, and uses the base sounding sequence g_{3,l} for sector C 933, which is also adjacent to sector B 922.

In FIG. 9B, the letter written in each sector denotes the allocated sequence group. Referring to FIG. 9B, BS A 960, BS B 970, BS C 980, and BS D 990 each manage three of the sectors 961, 962, 963, 971, 972, 973, 981, 981, 983, 991, 992 and 993. One base sounding group is allocated per sector. BS A 960, BS B 970, BS C 980, and BS D 990 direct the MS to transmit one of the sounding sequences in the sequence group of the sector where the MS travels. For instance, the BS A 960 directs the MS traveling in the sector A 961 to transmit one of the sounding sequences of group 1.

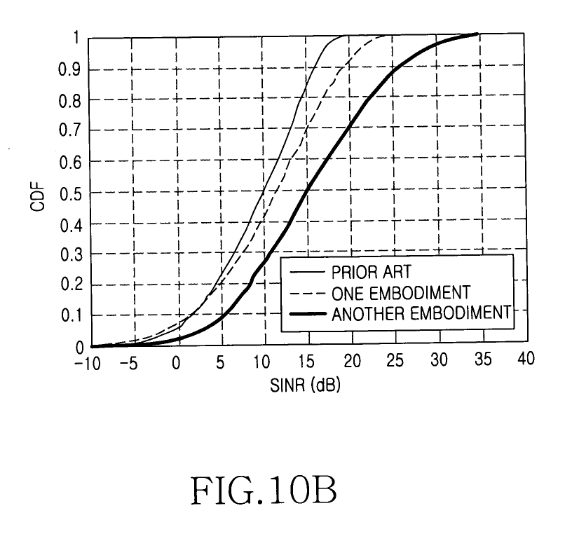

FIGS. 10A and 10B show the performance of the broadband wireless communication system according to an embodiment of the present invention. FIG. 10A depicts a Signal to Interference and Noise Ratio (SINR) probability distribution of the sounding signal when there is one MS per sector, and FIG. 10B depicts the SINR probability distribution of the sounding signal when there are four MSs per sector. In FIGS. 10A and 10B, the prior art is the sounding sequence allocation scheme defined by the Institute of Electrical and Electronics Engineers (IEEE) 802.16e system standard. As one can see in FIGS. 10A and 10B, the embodiments of the present invention exhibit the higher probability of detecting the high SINR than the prior art.

In the broadband wireless communication system in a multi-cell environment, the sounding performance can be enhanced by allocating the sounding sequences generated based on the Zadoff-Chu sequence to the sectors in consideration of the interference.

Although the present disclosure has been described with an embodiment, various changes and modifications may be suggested to one skilled in the art. It is intended that the present disclosure encompass such changes and modifications as fall within the scope of the appended claims.

What is claimed is:

1. A sounding sequence allocating method for a wireless communication system in a multi-cell environment, the method comprising:
grouping a plurality of sounding sequences to a plurality of sequence groups;
determining a correlation between the sequence groups;
determining a least interference relation between a plurality of sectors in a cluster; and
allocating the sequence groups to the sectors based on the correlation between the sequence groups and the least interference relation between the sectors.

2. The method of claim 1, further comprising:
generating the plurality of the sounding sequences.

3. The method of claim 2, wherein generating the plurality of the sounding sequences comprises:
generating a Zadoff-Chu sequence according to a preset root index;
generating a plurality of base sounding sequences by multiplying the Zadoff-Chu sequence by a plurality of covering codes; and
generating the plurality of the sounding sequences by applying cyclic shift to each of the base sounding sequences.

4. The method of claim 1, wherein allocating the sequence groups comprises:
allocating the sequence groups having the correlation to sectors having the least interference relation.

5. The method of claim 1, further comprising:
constituting one cluster with four cells each comprising three sectors.

6. The method of claim 5, wherein the sequence groups are twelve sequence groups, each sequence group comprising four sounding sequences.

7. The method of claim 1, wherein the correlation implies a mutual interference relation.

8. A sounding sequence allocating method for a wireless communication system of a multi-cell environment, the method comprising:
generating a plurality of base sounding sequences by multiplying a Zadoff-Chu sequence of a preset root index by a plurality of covering codes; and
allocating the base sounding sequences to sectors in a cell, such that each base sounding sequence allocated in the cell has been generated from a different first covering code.

9. The method of claim 7, wherein allocating the base sounding sequences comprises:
when sequence allocation is carried out for a neighbor cell of an allocation target cell, allocating the base sounding sequences in such a way as to prevent a sector of the allocation target cell and a sector of the neighbor cell, which are adjacent to each other, from being allocated base sounding sequences generated from a same first covering code.

10. A sounding sequence allocating apparatus for a wireless communication system of a multi-cell environment, the apparatus comprising:
a grouping part configured to group a plurality of sounding sequences to a plurality of sequence groups;
a first determiner configured to determine a correlation between the sequence groups;
a second determiner configured to determine a least interference relation between sectors in a cluster; and
an allocator configured to allocate the sequence groups to the sectors based on the correlation between the sequence groups and the least interference relation between the sectors.

11. The apparatus of claim 9, further comprising:
a generator configured to generate the plurality of the sounding sequences.

12. The apparatus of claim 10, wherein the generator is further configured to generate a Zadoff-Chu sequence according to a preset root index, generate a plurality of base sounding sequences by multiplying the Zadoff-Chu sequence by a plurality of covering codes, and generate the plurality of the sounding sequences by applying cyclic shift to each of the base sounding sequences.

13. The apparatus of claim 9, wherein the allocator allocates sequence groups having the correlation to sectors having the least interference relation.

14. The apparatus of claim 9, further comprising:
a constitutor configured to constitute one cluster with four cells each comprising three sectors.

15. The apparatus of claim 13, wherein the sequence groups are twelve sequence groups each comprising four sounding sequences.

16. The apparatus of claim 9, wherein the determined correlation implies a mutual interference relation.

17. A sounding sequence allocating apparatus for a wireless communication system of a multi-cell environment, the apparatus comprising:
a generator configured to generate a plurality of base sounding sequences by multiplying a Zadoff-Chu sequence of a preset root index by a plurality of covering codes; and
an allocator configured to allocate the base sounding sequences to sectors in a cell such that each base sounding sequence allocated in the cell has been generated from a different first covering code.

18. The apparatus of claim 15, wherein, when sequence allocation is carried out for a neighbor cell of a sequence allocation target cell, the allocator is further configured to allocate the base sounding sequences in such a way as to prevent a sector of the allocation target cell and a sector of the neighbor cell, which are adjacent to each other, from being allocated base sounding sequences generated from a same first covering code.

19. A wireless communication system of a multi-cell environment comprising:
a first base station belonging to a first cell of four cells constituting a cluster, the first base station configured to manage a first sector of four sectors with a least interference relation and control a first mobile station to perform sounding using sounding sequences of a first sequence group among four sequence groups that have correlation with respect to the first sector;
a second base station belonging to a second cell of the four cells constituting the cluster, the second base station configured to manage a second sector of the four sectors with the least interference relation and control a second mobile station to perform sounding using sounding sequences of a second sequence group among the four sequence groups that have correlation with respect to the second sector;
a third base station belonging to a third cell of the four cells constituting the cluster, the third base station configured to manage a third sector of the four sectors with the least interference relation and control a third mobile station to perform sounding using sounding sequences of a third sequence group among the four sequence groups that have correlation with respect to the third sector; and
a fourth base station belonging to a fourth cell of the four cells constituting the cluster, the fourth base station configured to manage a fourth sector of the four sectors with the least interference relation and control a fourth mobile station to perform sounding using sounding sequences of a fourth sequence group among the four sequence groups that have correlation with respect to the fourth sector.

20. A wireless communication system of a multi-cell environment comprising:
a first base station configured to control a first mobile station to perform sounding using sounding sequences generated from base sounding sequences which comprise first covering codes having different indexes with respect to sectors that constitute a cell of the first base station; and
a second base station configured to control a second mobile station to perform sounding using the sounding sequences generated from a base sounding sequence comprising a first covering code having a different index from an index of a first covering code of a base sounding sequence of a first sector with respect to at least one sector of the second base station, the at least one sector adjacent to a first sector of the first base station,
wherein the base sounding sequence is generated by multiplying a Zadoff-Chu sequence of a preset root index by a plurality of covering codes.
